(19) United States
(12) Patent Application Publication
(10) Pub. No.: US 2016/0025690 A1
(43) Pub. Date: Jan. 28, 2016

(54) FLOW PATH SWITCHING VALVE

(71) Applicant: SHIMADZU CORPORATION, Kyoto-shi, Kyoto (JP)

(72) Inventor: Kenichi Yasunaga, Kyoto-shi (JP)

(73) Assignee: SHIMADZU CORPORATION, Kyoto-shi, Kyoto (JP)

(21) Appl. No.: 14/774,456

(22) PCT Filed: Mar. 11, 2013
(86) PCT No.: PCT/JP2013/056574

§ 371 Date: Sep. 10, 2015

(51) Int. Cl. G01N 30/28; F16K 25/00; F16K 31/04; F16K 11/074

(52) U.S. Cl. CPC G01N 30/28; F16K 11/074; F16K 25/005; F16K 31/041; G01N 2030/027

(57) ABSTRACT

A stator and a rotor are in contact with each other while maintaining fluid tightness inside a housing including connection ports at an outer surface. The stator includes a port end portion arrangement surface that forms a part of an inner wall surface of the housing and where a plurality of holes that communicate with the connection ports are arranged. The rotor includes a flow path connection surface that is in contact with the port end portion arrangement surface of the stator while maintaining fluid tightness and to which a groove for selectively connecting the holes arranged at the port end portion arrangement surface is formed. At least one of the port end portion arrangement surface and the flow path connection surface is coated with a resin film having chemical resistance and slidability.

### TECHNICAL FIELD

The present invention relates to a flow path switching valve to be used by, for example, an autosampler for introducing a sample into an analytical flow path of a liquid chromatograph.

### BACKGROUND ART

As an example, an autosampler for introducing a sample into an analytical flow path of a liquid chromatograph transfers a sample in a sample loop by a mobile phase flowing through the analytical flow path to the side of a separation column, by collecting a sample into the sample loop from a sample container and connecting the sample loop to the upstream side of the separation column on the analytical flow path by switching of a flow path switching valve.

Generally, a rotary switching valve is used as a flow path switching valve used by a liquid chromatograph. The rotary switching valve switches the flow path to be connected by rotating a rotor (for example, see Patent Document 1).

The rotary switching valve includes a plurality of connection ports for connecting flow path pipes at the upper portion of a housing, and a rotor and a stator are accommodated inside the housing. The rotor and the stator are in contact with each other while maintaining fluid tightness between the planes, and the stator is fixed by a pin or the like so as not to rotate toward the housing side. Through holes are provided to the stator, at positions corresponding to the holes at the end portions of flow paths communicating with connection ports of the housing. A groove for communicating the end portions of the through holes of the stator are cut to the surface of the rotor on the stator side, and when the rotor is rotated while sliding against the stator, the position of the groove is changed, and connection between connection ports is switched.

### PRIOR ART DOCUMENTS

### Patent Documents

Patent Document 1: Japanese Patent Laid-open Publication No. 2008-215494

Patent Document 2: Japanese Patent Laid-open Publication No. 2008-202651

### SUMMARY OF THE INVENTION

### Problems to be Solved by the Invention

With a flow path switching valve as described above, resin such as PEEK (polyether ether ketone) or polyimide is used as the material for the rotor, and a ceramic or the like is used as the material for the stator. Also, in recent years, the stator is sometimes integrated with the housing, and in such a case, the surface of the stator portion is often coated with DLC (diamond-like carbon) with very good chemical resistance and slidability.

When the flow path switching valve is used over a long period of time, the sliding surface of the rotor (resin), which is softer than the stator (a ceramic or DLC), is worn, and this may cause a problem of cross contamination that is caused by a mobile phase remaining in the worn part of the rotor, in addition to problems such as an increase in the rotational torque of the rotor, leakage of a mobile phase, and the like.

Furthermore, to prevent fluid leakage from the sliding surfaces of the rotor and the stator, the rotor is pressed against the stator with great force, and when the rotor is rotated in this state, if the material of the rotor is resin, the surface of the rotor is scraped off by the friction of the rotation and chips are produced, and this may cause an analytical column connected at a later stage of the flow path switching valve to deteriorate. Also, in the case where the rotor is made of resin, the groove of the rotor may be deformed due to the rotor being pressed against the stator with great force, thereby making it difficult for fluid to flow through the groove of the rotor.

When the material for the rotor is a hard material such as a ceramic, production of chips from the rotor surface may be reduced, and the groove of the rotor may be prevented from being deformed. In this case, from the standpoint of fluid tightness between the rotor and the stator, the contact surfaces of both the rotor and the stator have to be mirror-finished by polishing, but when mirror-finished planes are pressed against each other with great force, there is a problem that a mirror adhesion phenomenon called linking occurs, causing a resistance to the rotational movement of the rotor, and the slidability of the rotor and the stator is impaired due to the resistance.

Accordingly, the present invention has its aim to reduce wear of the rotor and the stator without impairing the fluid tightness and the slidability of the sliding surfaces of the rotor and the stator.

### Solutions to the Problems

A flow path switching valve according to the present invention includes a housing including a plurality of connection ports for connecting flow path pipes at an outer surface, and including a space inside, a stator, provided inside the housing, including a port end portion arrangement surface that forms a part of an inner wall surface of the housing and where a plurality of holes that communicate with the connection ports are arranged, a rotor, arranged inside the housing, including a flow path connection surface that is in contact with the port end portion arrangement surface of the stator while maintaining fluid tightness and to which a groove for selectively connecting the holes arranged at the port end portion arrangement surface is formed, and a rotor driving section for rotating the rotor, where at least one of the port end portion arrangement surface and the flow path connection surface is coated with a resin film having chemical resistance and slidability.

### Effects of the Invention

According to the flow path switching valve of the present invention, at least one of the port end portion arrangement surface and the flow path connection surface is coated with a resin film having chemical resistance and slidability, and thus, the slidability between the stator and the rotor is increased, and wear of the stator or the rotor is reduced. Also, because a resin film is interposed between the stator and the rotor, the stress applied to the rotor is absorbed by the elasticity of the resin film, and deformation of the rotor groove is suppressed.

Additionally, the present inventor has proposed in Patent Document 2 to have one of a rotor and a stator made of resin and to coat the contact surface of the other with a chromium nitride film to thereby reduce the friction coefficient between the rotor and the stator and to suppress wear of the rotor and the stator. The present invention is a modification thereof, and an effect that deformation of the groove of the rotor is suppressed may be obtained by the present invention.

### BRIEF DESCRIPTION OF THE DRAWINGS

FIG. 1 is a cross-sectional diagram showing an embodiment of a flow path switching valve.

FIG. 2 is a cross-sectional diagram showing another embodiment of the flow path switching valve.

FIG. 3 is a cross-sectional diagram showing further another embodiment of the flow path switching valve.

FIG. 4 is a cross-sectional diagram showing further another embodiment of the flow path switching valve.

FIG. 5 is a cross-sectional diagram showing further another embodiment of the flow path switching valve.

FIG. 6 is a cross-sectional diagram showing further another embodiment of the flow path switching valve.

### EMBODIMENTS OF THE INVENTION

With a flow path switching valve of the present invention, in the case where a resin film is formed on only one of a port end portion arrangement surface and a flow path connection surface, the other is preferably coated with a film of diamond-like carbon. Since the diamond-like carbon has good wear resistance and slidability, the slidability between a stator and a rotor is increased, and wear of the stator and the rotor may be reduced.

Furthermore, in the case where the stator is also made of a hard material, a resin film is desirably formed on both the port end portion arrangement surface of the stator and the flow path connection surface of the rotor. The slidability between the stator and the rotor is thereby further increased.

The flatness of the surface of the resin film formed on the port end portion arrangement surface or the flow path connection surface is desirably 10 μm or less. Then, the fluid tightness between the port end portion arrangement surface of the stator and the flow path connection surface of the rotor is improved. Here, “the flatness is 10 μm or less” means that the maximum value of the difference between a recess and a protrusion of the same plane (the difference between the highest portion and the lowest portion) is 10 μm or less.

As the main component of the resin film, a polyether ether ketone resin or a polyamide resin may be cited. Additionally, a fluorine resin such as PTFE (polytetrafluoroethylene) or PFA (tetrafluoroethylene-perfluoroalkylvinylether copolymer), graphite, carbon and the like may be contained in these resins. When these materials are contained, the friction coefficient of the surface of the resin film is further reduced, the slidability between the stator and the rotor is increased, and wear of the stator and the rotor may be further reduced.

Furthermore, the rotor may be made of a hard material with higher hardness than resin. Deformation of the rotor caused by the rotor being pressed against the stator with great force may thereby be suppressed.

As the hard material, a ceramic such as alumina or zirconia may be cited in addition to metal such as stainless steel or titanium.

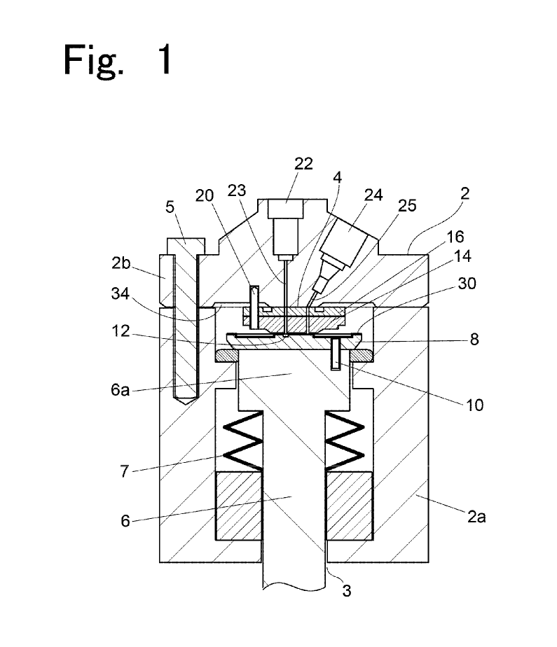

An embodiment of a flow path switching valve will be described with reference to FIG. 1.

A rotor 8 and a stator 14 are accommodated in the inner space of a housing 2. The housing 2 has a circular planar shape, and includes, at the outer surface of the upper portion, a plurality of connection ports 22 and 24 for connecting flow path pipes. A hole 3 is provided at the lower surface center portion of the housing 2, and a driving shaft 6, which is a part of a rotor driving section for rotating the rotor 8, penetrates the hole 3.

The housing 2 is formed from a housing body 2a and a housing top 2b. The housing body 2a has a cylindrical shape, and has the hole 3 opened at the center of the bearing surface. The housing top 2b having a disk shape is placed above an opening portion of the housing body 2a in a state where the opening portion is facing upward. The housing body 2a forms the base of the housing 2, and the housing top 2b is attached to the housing body 2a in an attachable/detachable manner by a bolt 5. The bolt 5 is fastened in such a way as to reach the housing body 2a from the upper surface side of the housing top 2b. A through hole for letting the bolt 5 penetrate is provided to the housing top 2b, and a screw hole is provided to the housing body 2a for fastening of the bolt 5. FIG. 1 shows only one attachment position of the bolt 5, but the bolts 5 are attached at three symmetrical positions on the peripheral portion of the plane seen from the upper surface side of the upper surface of the housing top 2b. Additionally, the attachment positions of the bolts 5 are not limited to the above.

A lower surface center portion 4 of the housing top 2b, which is an inner wall surface of the housing 2, is a plane where holes at the end portions of flow paths 23 and 25 that communicate with the connection ports 22 and 24 are arranged, and is a circular planar region surrounded by a ring-shaped recess 34. The stator 14 is in contact with the lower surface center portion 4 of the housing top 2b via a packing 16. The stator 14 and the packing 16 are circular members whose planar shapes are larger than the lower surface center portion 4, and the center portion of the packing 16 is in contact with the lower surface center portion 4 of the housing top 2b while maintaining fluid tightness. Because the recess 34 is provided at around the lower surface center portion 4 of the housing top 2b, the part of the housing top 2b that is in contact with the packing 16 is limited to a flow path connection section 4, and the fluid tightness at this part is improved by increasing the contact pressure applied between the flow path connection section 4 and the center portion of the packing 16.

Through holes corresponding to the holes at the end portions of the flow paths 23 and 25 arranged at the lower surface center portion 4 of the housing top 2b are provided to the stator 14 and the packing 16. The stator 14 and the packing 16 are fixed to the housing top 2b by a stator fixing pin 20 in a state where the through holes are positioned at the end portion holes of the flow paths 23 and 25 of the housing top 2b. A hole into which the stator fixing pin 20 is to be inserted is provided to the housing top 2b, and through holes through which the stator fixing pin 20 is to penetrate are provided to the stator 14 and the packing 16.

The rotor 8 is rotated inside the housing 2 by a rotor driving shaft 6. The rotor driving shaft 6 is arranged vertically to the plane of the lower surface center portion 4 of the housing top 2b, and a rotor holding section 6a is provided at its tip end. The tip end surface of the rotor holding section 6a is a plane that is parallel to the lower surface center portion 4 of the housing top 2b, and the rotor 8 is held at the tip end surface of the rotor holding section 6a. The upper surface (the flow path connection surface) of the rotor 8 is in contact with the lower surface (the port end portion arrangement surface) of the stator 14. The base end portion of the rotor driving shaft 6 passes through the hole 3 of the housing 2 and extends outside the housing 2, and is rotated around the shaft center by a rotating mechanism (not shown), such as a motor, outside the housing 2. The rotor holding section 6a and the rotor 8 are fixed together by a rotor fixing pin 10 in the rotation direction, and the rotor 8 is to rotate according to the rotation of the rotor driving shaft 6. A through hole through which the rotor fixing pin 10 is to penetrate is provided to the rotor 8, and a hole into which the rotor fixing pin 10 is to be inserted is provided to the rotor holding section 6a.

With the rotor driving shaft 6, the rotor holding section 6a at the tip end portion has an outer diameter greater than the shaft portion on the base end side. A compressed spring 7 is inserted between the bottom portion of the housing body 2a and the rotor holding section 6a, and the rotor driving shaft 6 is biased toward the housing top 2b side by the spring 7. The rotor 8 is thereby pressed against the stator 14. A groove 12 for forming a flow path that connects one of the plurality of flow paths 23 and 25 of the housing top 2b is provided to the surface of the rotor 8 on the stator 14 side, and the position of the groove 12 is changed by rotation of the rotor 8.

The rotor 8 is made of a hard material having chemical resistance, such as stainless steel or titanium and the surface on the stator 14 side is coated with a resin film 30 having good chemical resistance and slidability. The resin film 30 is, for example, a coating of a PEEK resin or a polyimide resin of about 100 μm on the surface of the rotor 8. The PEEK resin or the polyimide resin forming the resin film 30 may contain about 10% to 30% of a fluorine resin such as PTFE or PFA, graphite, carbon, or the like.

The resin film 30 is formed by spraying the powdered/liquefied PEEK resin on the surface on the stator 14 side, and adhering and hardening the PEEK by heating. For example, vicote coating provided by Victrex PLC is cited as a representative method.

Regarding coating of the surface of the rotor 8 with the resin film 30, it is desirable to form fine recesses and protrusions by blasting on the surface of the rotor 8 before coating with the resin to increase adhesiveness of the resin to the surface of the rotor 8, and to polish the surface of the rotor 8 after coating with the resin to make the flatness 10 μm or less. With the flatness of the surface of the rotor 8 made 10 μm or less by polishing, the fluid tightness at the sliding surface to the stator 14 may be improved.

The stator 14 is made of a material having chemical resistance such as metal, e.g. stainless steel or titanium, or a ceramic, e.g. alumina or zirconia, a PEEK resin, a polyimide resin, or the like. In the case where the stator 14 is made of stainless steel or titanium, its surface is desirably mirror-finished by polishing by diamond grains (particle diameter: 1 to 3 μm) to improve the slidability and the fluid tightness of the sliding surface to the rotor 8. Moreover, by applying a DLC coating having a thickness of about 2 μm on the mirror-finished surface of the stator 14, the slidability of the sliding surface to the rotor 8 may be further increased.

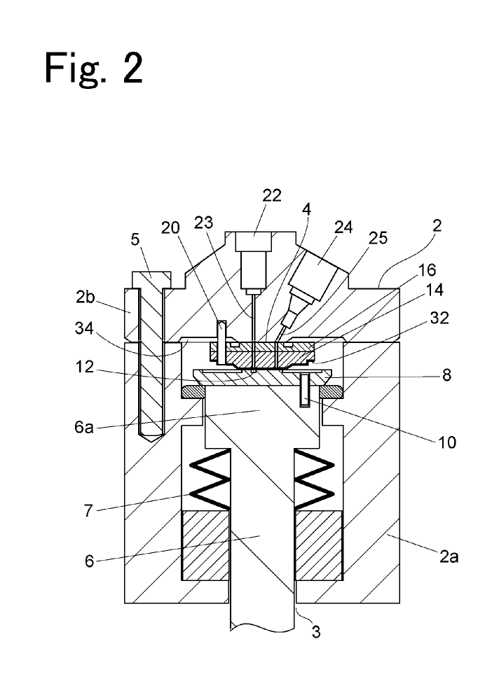

Additionally, in the embodiment in FIG. 1, the surface of the rotor 8 on the stator 14 side is coated with the resin film 30, but as shown in FIG. 2, the surface of the stator 14 on the rotor 8 side may alternatively be coated with a resin film 32. Like the resin film 30, the resin film 32 is a coating of a PEEK resin or a polyimide resin of about 100 μm on the surface of the stator 14. In this case, the stator 14 is made of a hard material having chemical resistance, such as stainless steel or titanium. Also at the time of coating with the resin film 32, as with the resin film 30 in FIG. 1, it is desirable to form fine recesses and protrusions by blasting on the surface of the stator 14, and to polish the surface of the stator 14 after coating with the resin to make the flatness 10 μm or less.

In the embodiment in FIG. 2, the rotor 8 is made of a material having chemical resistance such as metal, e.g. stainless steel or titanium, or a ceramic, e.g. alumina or zirconia, a PEEK resin, a polyimide resin, or the like. In the case where the rotor 8 is made of stainless steel or titanium, its surface is desirably mirror-finished by polishing by, for example, diamond grains (particle diameter: 1 to 3 μm) to improve the slidability and the fluid tightness of the sliding surface to the stator 14. Moreover, by applying, for example, a DLC coating having a thickness of about 2 μm on the mirror-finished surface of the rotor 8, the slidability of the sliding surface to the stator 14 may be further increased.

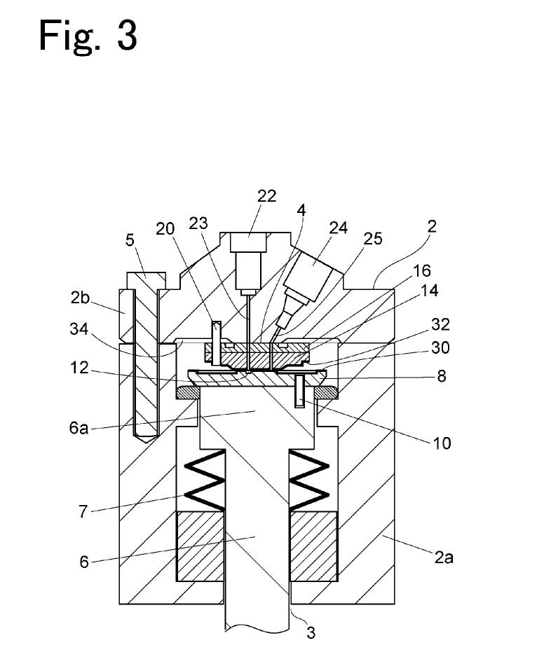

Furthermore, as shown in FIG. 3, the sliding surfaces, facing each other, of the rotor 8 and the stator 14 may be coated with the resin films 30 and 32, respectively. In this case, both the rotor 8 and the stator 14 are formed of stainless steel, titanium, or the like.

In the embodiments described above, the stator 14 and the housing 2 are provided as separate bodies, but the present invention is not limited to such a structure, and may also be applied to a case where the stator is integrated with the housing. With the stator integrated with the housing, the flow path length inside the flow path switching valve is reduced, and the dead volume inside the flow path switching valve is reduced. When the dead volume inside the flow path switching valve is reduced, if this flow path switching valve is used in a liquid chromatograph, diffusion of sample components in the flow path switching valve may be suppressed, and detection sensitivity may be increased.

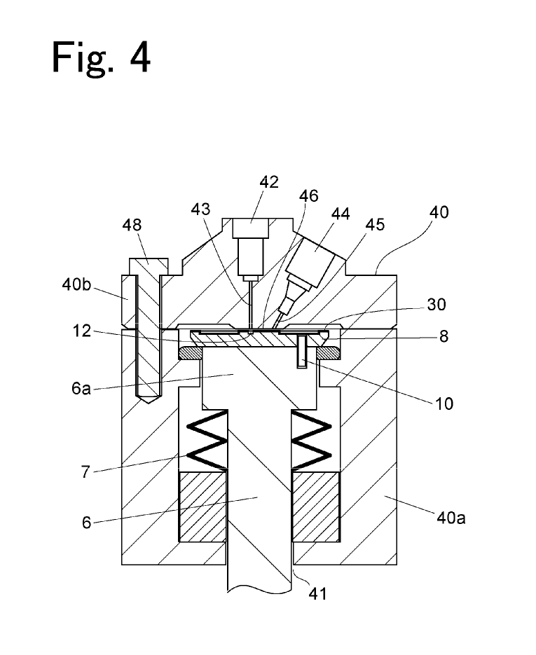

An embodiment of application of the present invention to a flow path switching valve where a stator is integrated with a housing will be described with reference to FIG. 4.

As in the embodiments described with reference to FIGS. 1 to 3, a housing 40 is formed from a housing body 40a and a housing top 40b, and the housing top 40b is placed, and fixed by a bolt 48, above the housing body 40a. Connection ports 42 and 44 are provided to the housing top 40b, and end portions of flow paths 43 and 45 that communicate with the connection ports 42 and 44 reach a lower surface center portion 46, of the housing top 40b, forming the inner wall surface of the housing 40. The lower surface center portion 46 of the housing top 40b forms the sliding surface to a rotor 8 (a port end portion arrangement surface), and a stator that slides against the rotor 8 is integrated with the housing top 40b.

The base end portion of a rotor driving shaft 6 passes through a hole 41 provided at the bottom portion of the housing body 40b and extends outside the housing 40, and is then rotated around the shaft center by a rotating mechanism (not shown), such as a motor, outside the housing 40.

The rotor 8 to be rotated by the rotor driving shaft 6 is made of a hard material having chemical resistance, such as stainless steel or titanium, and the surface on the stator 14 side is coated with a resin film 30 having good chemical resistance and slidability. The resin film 30 is the same as the resin film 30 described in the embodiments in FIGS. 1 and 3.

The material for the housing top 40b is metal such as stainless steel or titanium, or a ceramic such as alumina or zirconia. The lower surface center portion 46 of the housing top 40b is a sliding surface to the rotor 8, and thus, its surface is desirably mirror-finished by polishing by, for example, diamond grains (particle diameter: 1 to 3 μm). Moreover, by applying, for example, a DLC coating having a thickness of about 2 μm on the mirror-finished surface of the lower surface center portion 46 of the housing top 40b, the slidability to the rotor 8 may be further increased.

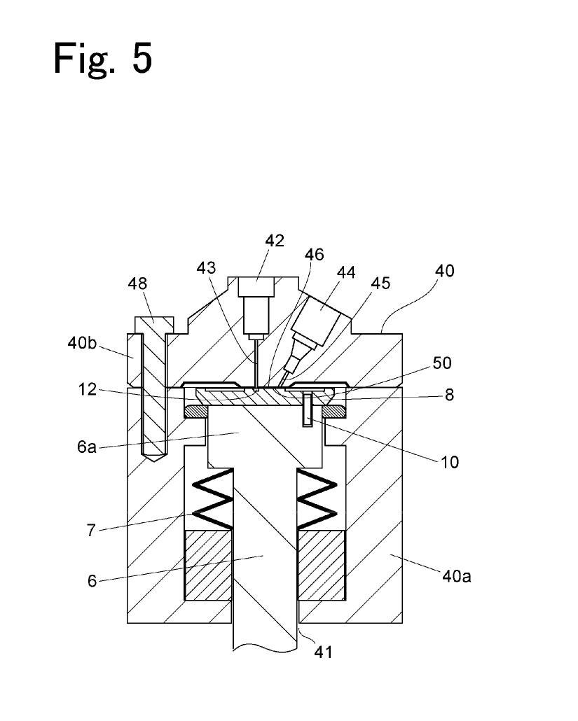

Additionally, as shown in FIG. 5, the lower surface of the housing top 40b may be coated with a resin film 50. Like the resin film 30, the resin film 50 is a coating of a PEEK resin or a polyimide resin having a thickness of about 100 μm on the lower surface of the housing top 40b. In this case, the housing top 40b is made of, for example, stainless steel or titanium. At the time of coating the lower surface of the housing top 40b with the resin film 50, it is desirable to form fine recesses and protrusions on the lower surface of the housing top 40b (excluding the part that is in contact with the housing body 40a) by blasting, and to polish the surface of coating after coating with resin to make the flatness 10 μm or less.

In the embodiment in FIG. 5, the rotor 8 is made of a material having chemical resistance such as metal, e.g. stainless steel or titanium, or a ceramic, e.g. alumina or zirconia, a PEEK resin, a polyimide resin, or the like. In the case where the rotor 8 is made of stainless steel or titanium, its surface is desirably mirror-finished by polishing by, for example, diamond grains (particle diameter: 1 to 3 μm) to improve the slidability and the fluid tightness of the sliding surface to the housing top 40b. Moreover, by applying, for example, a DLC coating having a thickness of about 2 μm on the mirror-finished surface of the rotor 8, the slidability of the sliding surface to the stator 14 may be further increased.

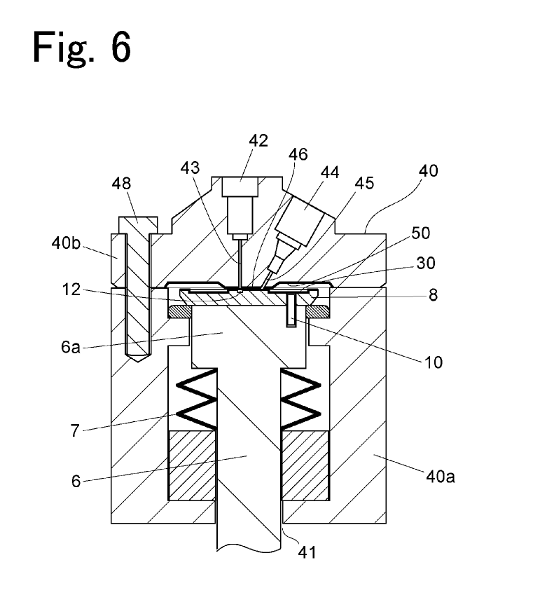

Furthermore, as shown in FIG. 6, the sliding surfaces, facing each other, of the rotor 8 and the housing top 40b may be coated with the resin films 30 and 50, respectively. In this case, both the rotor 8 and the housing top 40b are formed of stainless steel, titanium, or the like.

### DESCRIPTION OF REFERENCE SIGNS

2, 40: Housing
2a, 40a: Housing body
2b, 40b: Housing top
3, 41: Through hole for rotor driving shaft
4, 46: Lower surface center portion of housing top (port end portion arrangement surface)
5, 48: Bolt
6: Rotor driving shaft
6a: Rotor holding section
7: Spring
8: Rotor
10: Rotor fixing pin
12: Groove
14: Stator
16: Packing
20: Stator fixing pin
22, 24, 42, 44: Connection port
23, 25, 43, 45: Flow path
30, 32, 50: Resin film
34: Recess

1. A flow path switching valve comprising:
a housing including a plurality of connection ports for connecting flow path pipes at an outer surface, and including a space inside;
a stator, provided inside the housing, including a port end portion arrangement surface that forms a part of an inner wall surface of the housing and where a plurality of holes that communicate with the connection ports are arranged;
a rotor, arranged inside the housing, including a flow path connection surface that is in contact with the port end portion arrangement surface of the stator while maintaining fluid tightness and to which a groove for selectively connecting the holes arranged at the port end portion arrangement surface is formed; and
a rotor driving section for rotating the rotor,
wherein at least one of the port end portion arrangement surface and the flow path connection surface is coated with a resin film having chemical resistance and slidability.

2. The flow path switching valve according to claim 1, wherein only one of the port end portion arrangement surface and the flow path connection surface is coated with the resin film, and another is coated with diamond-like carbon.

3. The flow path switching valve according to claim 1, wherein both the port end portion arrangement surface and the flow path connection surface are coated with the resin film.

4. The flow path switching valve according to claim 1, wherein flatness of a surface of the resin film is 10 μm or less.

5. The flow path switching valve according to claim 1, wherein a main component of the resin film is a polyether ether ketone resin or a polyamide resin.

6. The flow path switching valve according to claim 1, wherein the rotor is made of a hard material having higher hardness than resin.

7. The flow path switching valve according to claim 6, wherein the hard material is metal or a ceramic.
